(19) United States
(12) Patent Application Publication
(10) Pub. No.: US 2022/0134877 A1
(43) Pub. Date: May 5, 2022

(54) SYSTEMS AND METHODS FOR MOVING ONE OR MORE DISPLAYS IN A VEHICLE BASED ON VEHICLE OCCUPANT LOCATION

(71) Applicant: Ford Global Technologies, LLC, Dearborn, MI (US)

(72) Inventors: Mark Larry, Macomb, MI (US); Biaohe Guo, Northville, MI (US)

(73) Assignee: Ford Global Technologies, LLC, Dearborn, MI (US)

(21) Appl. No.: 17/085,638

(22) Filed: Oct. 30, 2020

(51) Int. Cl. B60K 35/00; B60R 11/02; B60R 1/00; G06K 9/00

(52) U.S. Cl. CPC B60K 35/00; B60R 11/02; B60R 1/00; G06K 9/00838; B60R 2300/8006; B60K 2370/67; B60K 2370/741; B60R 2300/20; G06K 9/00369

(57) ABSTRACT

A vehicle comprising a sensor, a moveable display, and a controller. The controller is configured to determine a location of an occupant within the vehicle and, based on the location of the occupant within the vehicle, move the moveable display.

### BACKGROUND

Vehicles may be equipped with multiple displays for different purposes, such as instrument cluster displays and center stack displays. In some instances, each display is designed for and serves one purpose. When it comes to autonomous vehicles, more displays may be incorporated into the vehicle for more applications, such as passenger entertainment and in-vehicle information sharing. However, the incorporation of more displays may result in increased vehicle costs.

More so, fixed-position displays may be inefficient for ride hailing vehicles because the number and position of passengers may change each trip.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts a system for moving one or more displays within a vehicle based on location data associated with one or more occupants within the vehicle in accordance with one or more embodiments of the disclosure.

FIG. 2 schematically depicts a camera image in accordance with one or more embodiments of the disclosure.

FIG. 3 schematically depicts various display locations in accordance with one or more embodiments of the disclosure.

FIG. 4A schematically depicts a positioning system in accordance with one or more embodiments of the disclosure.

FIG. 4B schematically depicts a positioning system in accordance with one or more embodiments of the disclosure.

FIG. 5 schematically depicts a system for moving one or more displays within a vehicle based on location data associated with one or more occupants within the vehicle in accordance with one or more embodiments of the disclosure.

FIG. 6 schematically depicts various display locations in accordance with one or more embodiments of the disclosure.

FIG. 7 depicts a flow diagram in accordance with one or more embodiments of the disclosure.

FIG. 8 depicts a flow diagram in accordance with one or more embodiments of the disclosure.

FIG. 9 depicts a flow diagram in accordance with one or more embodiments of the disclosure.

### DETAILED DESCRIPTION

### Overview

The disclosure is directed to systems and methods for moving one or more displays within a vehicle based on location data associated with one or more occupants within the vehicle. For example, the one or more displays may be automatically moved to optimal viewing positions within the vehicle based on the number and position of the one or more occupants within the vehicle, such as the location of the occupants within various seats within the vehicle. One or more sensors (e.g., a camera) may be used to determine the number and position of the occupants within the vehicle. Other sensors may be used as well, including weight sensors within seats, sonar, radar, lidar, etc. to determine the number and location of the occupants within the vehicle.

In some instances, the vehicle may be an autonomous vehicle (including levels 1-5 of autonomy). Any vehicle may be used herein. In certain embodiments, whether autonomous or not, the vehicle may be part of a bus service or a ride hailing service, in which the vehicle is used to pick-up and drop-off customers. In such instances, the sensors within the vehicle may periodically or continuously monitor the interior of the vehicle to determine the number and location of occupants within the vehicle, as such information may change as customers are picked-up and dropped-off. Occupants may also move about the vehicle while the vehicle is moving between stops. Based on the number and position of the one or more occupants within the vehicle, as determined by the sensors, the one or more displays within the vehicle may be automatically moved to optimal or preferred viewing positions within the vehicle.

### Illustrative Embodiments

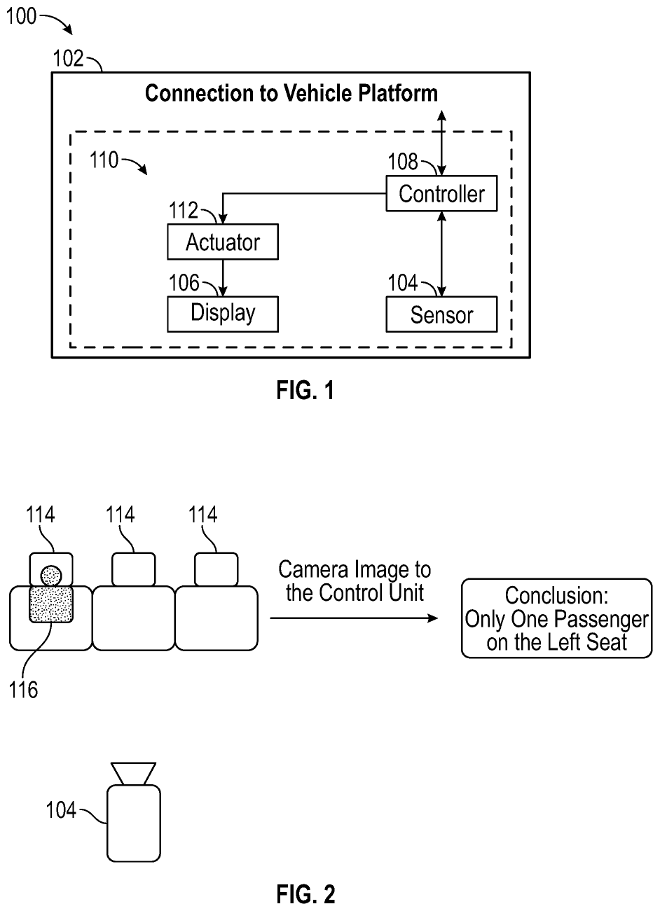

FIG. 1 schematically depicts a system 100 for moving one or more displays within a vehicle based on location data associated with one or more occupants within the vehicle. The system 100 may include a vehicle 102, a sensor 104 (e.g., a camera), a moveable display 106, and a controller 108. The controller 108 may be configured to determine a location of an occupant within the vehicle 102 and move, based on the location of the occupant within the vehicle 102, the moveable display 106. The controller may include memory and one or more processors configured to execute the instructions discussed herein. The controller 108 may be in communication with a vehicle controller or other vehicle subsystems and subsystem controllers.

The moveable display 106 may be moved (or repositioned) within the vehicle 102 by way of a positioning system 110. The positioning system 110 may include an actuator 112 in communication with the moveable display 106. The actuator 112 may move the moveable display 106 based on one or more commands from the controller 108.

In some instances, the vehicle 102 may be manually driven. In other instances, the vehicle 102 may be fully or partially autonomous. For example, the vehicle 102 may be an autonomous vehicle (e.g., levels 1-5 of autonomy). Any vehicle may be used herein for any purpose. In certain embodiments, whether autonomous or not, the vehicle 102 may be part of a ride hailing service, in which the vehicle 102 is used to pick-up and drop-off customers.

The sensor 104 may include a camera. Any suitable camera may be used herein. In some instances, multiple cameras may be used. For example, the camera may be an RGB camera and/or IR camera mounted within the interior of the vehicle. The camera may be located at any suitable position within the vehicle. In other instances, the camera may be mounted on an exterior of the vehicle 102.

As depicted in FIG. 2, the camera may be configured to monitor one or more seats 114 within the vehicle 102. In certain embodiments, the camera may be configured to constantly take videos and/or images of the seats 114 within the vehicle 102 in order to determine if one or more occupants 116 are seated in the seats 114. The data collected by the camera may be provided to the controller 108. The controller 108 may then make a determination as to the location of the occupants 116 within the seats 114. For example, as depicted in FIG. 2, the camera may capture an image of an occupant 116 in the far left seat. This image information may be provided to the controller 108, which processes said information to determine that only one occupant 116 is located in the far left seat of the vehicle 102.

The controller 108 may determine the location of the occupant 116 by analyzing the shape and/or temperature of the object in the seat 114. In this way, the controller 108 can distinguish a human being from other objects, such as an animal or luggage. When the controller 108 determines the number and location of occupants, the controller 108 can send commands to the actuator 112 to move (or not) the moveable display 106 based on the number of occupants and the location of the occupants.

Other sensors may be used in lieu of or in conjunction with the camera. For example, the sensor may comprise weight sensors within seats 114, sonar sensors, radar sensors, lidar sensors, heat sensors, motion sensors, etc. that are configured to determine (individually or collectively) the number and location of the occupants 116 within the vehicle 102. That is, the various sensor data from the various different sensors may be provided to the controller 108, which may process the data through one or more algorithms to determine the number and location of occupants within the vehicle.

The display 106 may be any suitable display. For example, the display may comprise a liquid crystal display (LCD), an LCD with backlit lighting-emitting diode (LED), a plasma panel, an electroluminescent panel, an organic LED, a quantum dot LED, etc. The display 106 may be any suitable size, shape, or configuration.

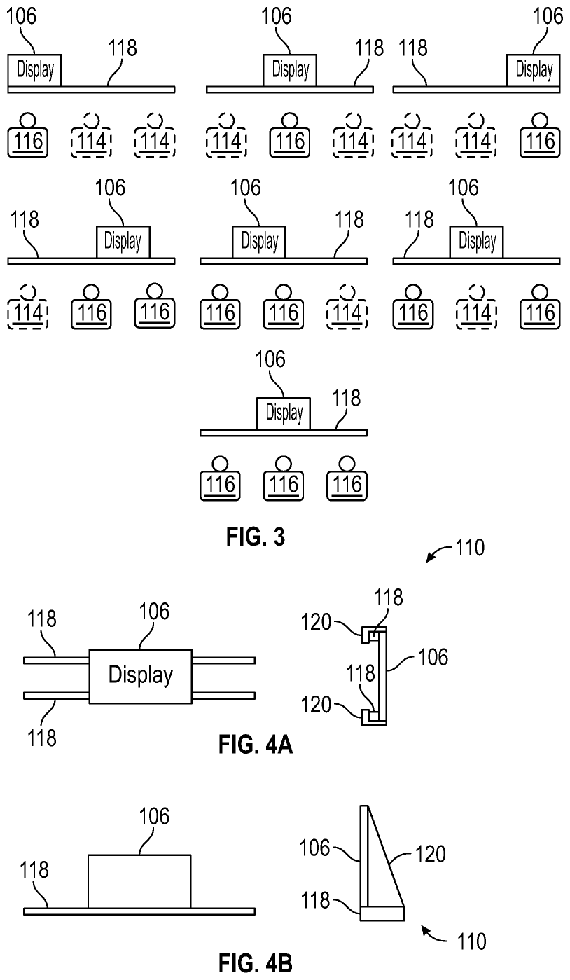

As depicted in FIG. 3, the moveable display 106 may be moveable around the interior of the vehicle 102. Although the interior of the vehicle 102 is depicted as having three seats 114 in a row, the vehicle 102 can have more or fewer seats arranged in any configuration. For example, the vehicle may have multiple rows with various seats. In this manner, the system 100 is configured to move the moveable display 106 based on which seats the one or more occupants are located at in within the vehicle 102.

In one example embodiment, if the controller 108 determines that the vehicle 102 includes a single occupant in a far left seat, then the controller can send a command to the actuator 112 to move the moveable display 106 to a position in front of the far left seat. In another example embodiment, if the controller 108 determines that the vehicle 102 includes a single occupant in the center seat, then the controller can send a command to the actuator 112 to move the moveable display 106 to a position in front of the center seat. In another example embodiment, if the controller 108 determines that the vehicle 102 includes a single occupant in a far right seat, then the controller can send a command to the actuator 112 to move the moveable display 106 to a position in front of the far right seat. In another example embodiment, if the controller 108 determines that the vehicle 102 includes one occupant in a center seat and another occupant in a far right seat, then the controller can send a command to the actuator 112 to move the moveable display 106 to a position between the center and far right seat. In another example embodiment, if the controller 108 determines that the vehicle 102 includes one occupant in a center seat and another occupant in a far left seat, then the controller can send a command to the actuator 112 to move the moveable display 106 to a position between the center and far left seat. In another example embodiment, if the controller 108 determines that the vehicle 102 includes one occupant in far left seat and another occupant in a far right seat, then the controller can send a command to the actuator 112 to move the moveable display 106 to a position between the far left seat and the far right seat. In another example embodiment, if the controller 108 determines that the vehicle 102 includes an occupant in each of the three seats, then the controller can send a command to the actuator 112 to move the moveable display 106 to a center position.

FIGS. 4A and 4B depict example embodiments of the repositioning system 110. In some instances, the repositioning system 110 may include a track 118. The moveable display 106 may be attached to the track 118 and may be moveable about the track 118. As depicted in FIG. 4A, the repositioning system 110 may include multiple tracks 118. As depicted in FIG. 4B, the repositioning system 110 may include a single track 118. A pedestal 120 may act as an intermediary between the moveable display 106 and the track 118. For example, the moveable display 106 may be attached to the pedestal 120, and the pedestal 120 may be attached to the track 118. In this manner, the pedestal 120 may move along the track 118, which in turn may move the moveable display 106. The actuator 112 may be in communication with the pedestal 120. In other instances, the pedestal 120 may be omitted, and the moveable display 106 may be attached to the track 118 and the actuator 112. The repositioning system 110 may include any suitable mechanical system configured to move the moveable display 106.

In some instances, each moveable display 106 is configured to be attached to the pedestal 120. The pedestal 120 can then be connected to the actuator 112 (e.g., a motor), which is used to move the moveable display 106. In some instances, the positioning system 110 may include a number of actuators 112. For example, each moveable display 106 can be controlled by an independent motor, or all moveable displays 106 can be controlled by one motor (e.g., with a moving belt or the like). The track 118 can be located anywhere within the vehicle 102. In some instances, the track 118 can include one or more docking stations along the track 118 to lock the moveable displays 106 in place along the track 118 based on seat positions.

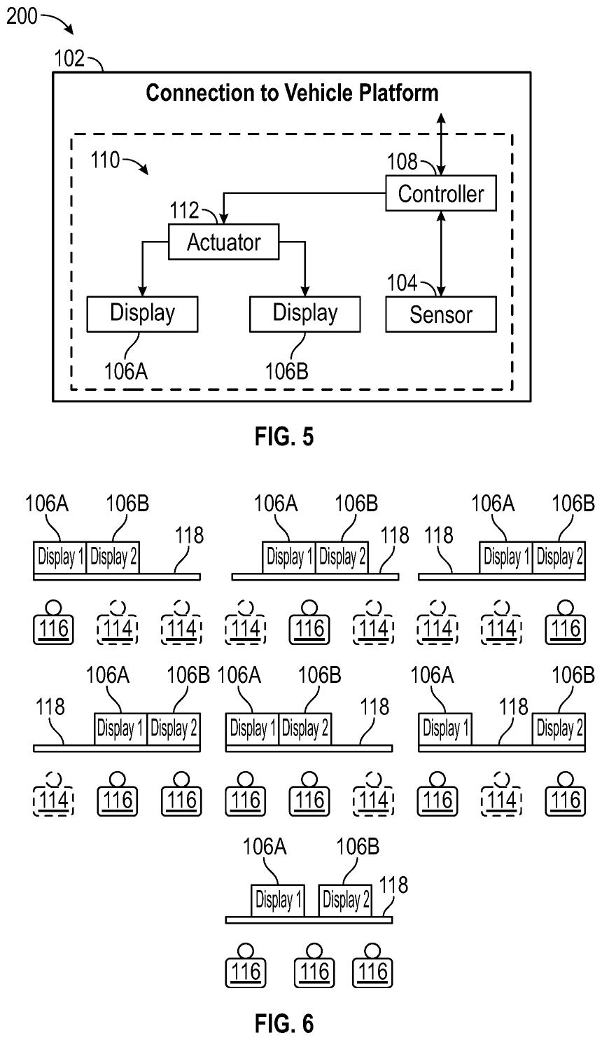

FIG. 5 schematically depicts a system 200 for moving one or more displays within a vehicle based on location data associated with one or more occupants within the vehicle. The system 200 is similar to the system 100. The system 200 includes multiple moveable displays 106A and 106B. The system 200 may include any number of moveable displays.

As depicted in FIG. 6, the moveable displays 106A and 106B may be moveable around the interior of the vehicle 102. Although the interior of the vehicle 102 is depicted as having three seats 114 in a row, the vehicle 102 can have more or fewer seats arranged in any configuration. For example, the vehicle may have multiple rows with various seats. In this manner, the system 200 is configured to move the moveable displays 106A and 106B based on which seats one or more occupants are located at in within the vehicle 102. In one example embodiment, if the controller 108 determines that the vehicle 102 includes a single occupant in a far left seat, then the controller can send a command to the actuator 112 to move the moveable displays 106A and 106B to a position in front of the far left seat. In another example embodiment, if the controller 108 determines that the vehicle 102 includes a single occupant in the center seat, then the controller can send a command to the actuator 112 to move the moveable displays 106A and 106B to a position in front of the center seat. In another example embodiment, if the controller 108 determines that the vehicle 102 includes a single occupant in a far right seat, then the controller can send a command to the actuator 112 to move the moveable displays 106A and 106B to a position in front of the far right seat. In another example embodiment, if the controller 108 determines that the vehicle 102 includes one occupant in a center seat and another occupant in a far right seat, then the controller can send a command to the actuator 112 to move the moveable displays 106A and 106B to a position between the center and far right seat. In another example embodiment, if the controller 108 determines that the vehicle 102 includes one occupant in a center seat and another occupant in a far left seat, then the controller can send a command to the actuator 112 to move the moveable displays 106A and 106B to a position between the center and far left seat. In another example embodiment, if the controller 108 determines that the vehicle 102 includes one occupant in far left seat and another occupant in a far right seat, then the controller can send a command to the actuator 112 to move the moveable display 106A in front of the far left seat and the moveable display 106B in front of the far right seat. In another example embodiment, if the controller 108 determines that the vehicle 102 includes an occupant in each of the three seats, then the controller can send a command to the actuator 112 to move the moveable display 106A between the left and center occupants and the moveable display 106B between the right and center occupants.

In certain embodiments, when passengers are onboard the vehicle and the vehicle is on and ready to go, the camera is configured to monitor the number and position information of passengers and send said information to the controller. The controller may analyze the information and then command the actuator to move the moveable display to preferred or optimal locations based on the number and position of passengers. The track may include docking stations that can lock the moveable display in its position along the track. The system is also configured to move the moveable display again when passengers change seats.

### Illustrative Methods

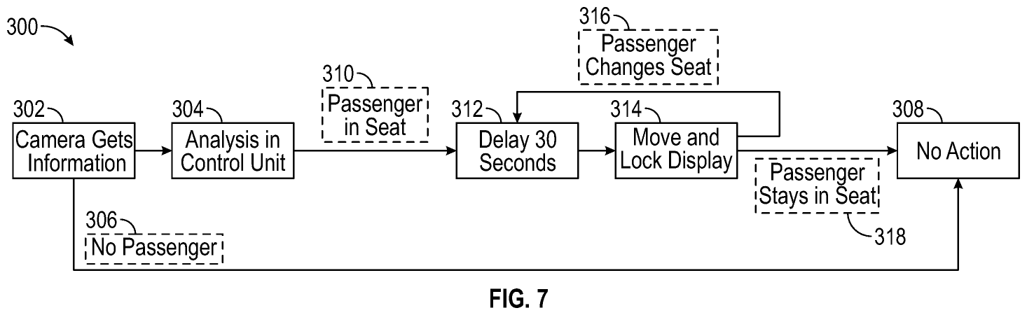

FIG. 7 is a flow diagram depicting an illustrative method 300 for moving one or more displays within a vehicle based on location data associated with one or more occupants within the vehicle in accordance with one or more embodiments of the disclosure. In some instances, the controller is configured to delay, after determining the location of the occupant within the vehicle, movement of the moveable display for a predetermined period of time. This may prevent excessive movement of the moveable displays as occupants move about the vehicle.

At block 302, the camera may monitor the interior of the vehicle and send said information to the controller. The controller may analyze the information from the camera at block 304. If the controller determines that there are no passengers within the vehicle at block 306, then no action is taken to move the moveable displays at block 308. If the controller determines that there are passengers within the vehicle at block 310, then the controller implements a time delay (e.g., 30 second) at block 312, before moving the moveable displays at block 314. In the passengers change seats again at block 316, then the time delay at block 312 is implemented again. If the passengers do not change seats at block 318, then no action is taken.

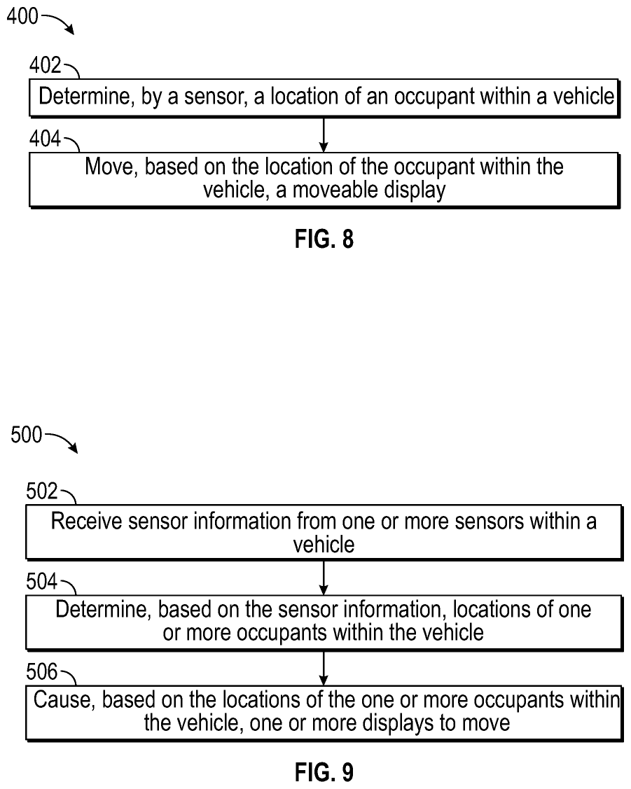

FIG. 8 is a flow diagram depicting an illustrative method 400 for moving one or more displays within a vehicle based on location data associated with one or more occupants within the vehicle in accordance with one or more embodiments of the disclosure. At block 402 of the method 400, the controller may determine, by a sensor, a location of an occupant within a vehicle. At block 404 of the method 400 the controller may cause the moveable display to move within the vehicle based on the location of the occupant within the vehicle.

FIG. 9 is a flow diagram depicting an illustrative method 500 for moving one or more displays within a vehicle based on location data associated with one or more occupants within the vehicle in accordance with one or more embodiments of the disclosure. At block 502 of the method 500, the controller may receive sensor information from one or more sensors disposed within the vehicle. At block 504 of the method 500, the controller may determine, based on the sensor information, locations of one or more occupants within the vehicle. At block 506 of the method 500, the controller may cause one or more moveable displays to move within the vehicle based on the locations of the occupants within the vehicle.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, while embodiments of the disclosure have been described with respect to specific configurations, numerous other configurations are within the scope of this disclosure. Still further, while embodiments of the disclosure have been described with respect to specific types or configurations of systems and devices, numerous other types and configurations are within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments.

That which is claimed is:

1. A vehicle, comprising:
a sensor;
a moveable display; and
a controller configured to:
determine a location of an occupant within the vehicle, and
move, based on the location of the occupant within the vehicle, the moveable display.

2. The vehicle of claim 1, wherein the sensor comprises a camera.

3. The vehicle of claim 1, wherein the location comprises a seat within the vehicle.

4. The vehicle of claim 1, wherein the controller is configured to delay, after determining the location of the occupant within the vehicle, movement of the moveable display for a predetermined period of time.

5. The vehicle of claim 1, further comprising a positioning system attached to the moveable display and configured to move the moveable display.

6. The vehicle of claim 5, wherein the positioning system comprises a track, wherein the moveable display is attached to the track and is moveable about the track.

7. The vehicle of claim 6, wherein the positioning system comprises a pedestal configured to attach the moveable display to the track.

8. The vehicle of claim 5, wherein the positioning system comprises an actuator in communication with the controller, wherein the actuator is configured to move the moveable display.

9. The vehicle of claim 5, wherein the positioning system comprises a docking station.

10. The vehicle of claim 9, wherein the docking station is associated with a seat location within the vehicle.

11. A vehicle, comprising:
at least one sensor;
a plurality of moveable displays; and
a controller configured to:
determine a location of one or more occupants within the vehicle, and
move, based on the location of the one or more occupants within the vehicle, the plurality of moveable displays.

12. The vehicle of claim 11, wherein the at least one sensor comprises a camera.

13. The vehicle of claim 11, wherein the location of the one or more occupants comprises one or more seats within the vehicle in which the one or more occupants are located.

14. The vehicle of claim 11, wherein the controller is configured to delay, after determining the location of the one or more occupants within the vehicle, movement of the plurality of moveable displays for a predetermined period of time.

15. The vehicle of claim 11, further comprising a track, wherein the plurality of moveable displays are attached to the track and are moveable about the track.

16. The vehicle of claim 15, further comprising one or more actuators in communication with the controller, wherein the one or more actuators are configured to move the plurality of moveable displays.

17. The vehicle of claim 15, wherein the track comprises one or more docking stations.

18. The vehicle of claim 17, wherein the one or more docking stations are associated with seat locations within the vehicle.

19. A method, comprising:
determining, by a sensor, a location of an occupant within a vehicle; and
moving, based on the location of the occupant within the vehicle, a moveable display within the vehicle.

20. The method of claim 19, further comprising delaying, after determining the location of the occupant within the vehicle, movement of the moveable display for a predetermined period of time.
